(19) United States
(12) Patent Application Publication
(10) Pub. No.: US 2009/0059043 A1
(43) Pub. Date: Mar. 5, 2009

(54) PORTABLE ELECTRONIC DEVICE HAVING HIGH-RESOLUTION CAMERA WITH AUTO FOCUS LENS

(76) Inventor: Randolph Cary Demuynck, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/849,549

(22) Filed: Sep. 4, 2007

(51) Int. Cl. H04N 5/335; H04N 5/225

(52) U.S. Cl. 348/294; 348/340; 348/E05.091; 348/E05.024

(57) ABSTRACT

An improved system for incorporating a high-resolution digital camera function into a multifunction portable electronic device is provided. In exemplary embodiments, a clamshell portable electronic device, such as a mobile telephone, is provided with a digital camera function. The lens of the camera function is located in one portion of the clamshell, and the image sensor is located in another portion of the clamshell. When the clamshell is closed, the lens and image sensor become optically aligned so that the camera function may be employed. By providing a system in which the digital camera function is used with the clamshell in the closed position, the potential focal length is effectively doubled as compared to that in the typical clamshell mobile telephone.

### TECHNICAL FIELD OF THE INVENTION

The technology of the present disclosure relates generally to portable electronic devices, and more particularly to a portable electronic device that includes a high-resolution digital camera function.

### DESCRIPTION OF THE RELATED ART

Portable electronic devices commonly have a digital camera function. Due to the small size of such devices, however, it has been difficult to achieve the high resolution commonly attained in “stand-alone” digital cameras. Because of the typical low resolution, the camera function of a multifunction portable electronic device often is relegated to secondary usage when a stand-alone digital camera is not readily available. There currently appears to be no convenient method to incorporate a high-resolution digital camera function into a multifunction portable electronic device.

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera, an Internet browser for accessing news and information, an audiovisual media player, a messaging device (text, audio, and/or visual messages), a gaming device, a personal organizer, and have other functions as well.

Despite this increase in functionality, the size of portable electronic devices is ever decreasing to enhance portability. Although the size decrease has not impeded many device functions, the small size presents particular challenges for providing a high-resolution digital camera function. Camera resolution in part is determined by the focal length—the distance between the lens and the surface of an image sensor that captures the image to be photographed. Other features being equal, the larger the focal length, the greater the typical potential resolution of the camera. Therefore, as the overall thickness of a portable electronic device becomes smaller, so does the maximum camera focal length, which tends to decrease the potential resolution of the camera.

A common configuration of portable electronic devices, and mobile telephones in particular, is the “clamshell” configuration. As is known in the art, in a typical clamshell telephone, the device is divided substantially into two halves, an upper portion and a lower portion, connected with a hinge-like structure. When the clamshell is open, the inner surfaces of both portions are accessible to the user. The upper portion commonly contains a display, and the lower portion commonly contains a numeric keypad and other functional input devices or buttons, although various clamshell device configurations may be employed. The upper portion may be pivoted about the hinge-like structure to close over the lower portion.

The clamshell configuration has certain advantages over a block or brick configuration. In the open position, the surface area of the face of the device is essentially doubled. This permits larger displays and increased functionality by allowing larger and more detailed keypads and input options. It often is more difficult, however, to incorporate a high-resolution digital camera into the clamshell configuration. In the typical configuration, as is common in mobile telephones, the camera function is accessed when the clamshell is in the open position. In addition, the optical elements of the camera (the lens and image sensor) usually are located in one portion of the clamshell, which has only about half the thickness of the device when in the closed position. Current clamshells may be as thin as about 10 mm when closed, which means only approximately 5.0 mm is available in one clamshell portion to provide the focal length for the camera. With such thin dimensions, achieving a high-resolution camera function is difficult. Using current lens and imaging technology, the maximum resolution achievable is approximately 3.2 megapixels, and the actual resolution often is substantially lower.

### SUMMARY

To improve the consumer experience with portable electronic devices, there is a need in the art for an improved system for incorporating a high-resolution digital camera function into a multifunction portable electronic device. In exemplary embodiments, a clamshell portable electronic device, such as a mobile telephone, is provided with a digital camera function. The lens of the camera function is located in one portion of the clamshell, and the image sensor is located in another portion of the clamshell. When the clamshell is closed, the lens and image sensor become optically aligned so that the camera function may be employed. By providing a system in which the digital camera function is used with the clamshell in the closed position, the potential focal length is effectively doubled as compared to that in the typical clamshell mobile telephone.

Therefore, according to one aspect of the invention, an electronic device having a camera function comprises a first portion having a camera lens, and a second portion having a camera image sensor, wherein the first portion and second portion are movable relative to one another between an open position and a closed position, such that when in the open position the camera lens and the camera image sensor are not optically aligned, and when in the closed position the camera lens and camera image sensor are optically aligned to permit the camera function to be employed.

According to one embodiment of the electronic device, the electronic device has a clamshell configuration such that the first portion and second portion may be pivoted about one another between the open position and the closed position.

According to one embodiment of the electronic device, the second portion includes a hinge portion in communication with an upper portion of the clamshell of the electronic device, and the first portion is a lower portion of the clamshell of the electronic device, wherein the camera image sensor is located in the hinge portion and the camera lens is located in the lower portion of the clamshell.

According to one embodiment of the electronic device, the electronic device has a slide cover configuration such that the first portion and the second portion may be slid longitudinally relative to one another between the open position and the closed position.

According to one embodiment of the electronic device, the camera lens is an autofocus lens.

According to one embodiment of the electronic device, the electronic device further comprises a grommet, wherein when the electronic device is in the closed position, the grommet provides a sealing layer between the camera lens and the camera image sensor.

According to one embodiment of the electronic device, the electronic device further comprises a display viewable when the electronic device in the closed position, wherein the display acts as the viewfinder of the camera function.

According to one embodiment of the electronic device, the first portion has a receptor for removably receiving the camera lens.

According to one embodiment of the electronic device, the receptor of the first portion comprises screw threads, and the camera lens has opposite screw threads for removably cooperating with the screw threads on the first portion.

According to one embodiment of the electronic device, the resolution of the camera function is at least three megapixels.

According to one embodiment of the electronic device, the electronic device is a mobile telephone.

According to another aspect of the invention, a camera system comprises an electronic device having a camera function comprising a first portion for removably receiving a camera lens and a second portion having a camera image sensor, wherein the first and second portions are movable relative to one another between an open position and a closed position, such that when in the open position a received camera lens and the camera image sensor are not optically aligned, and when in the closed position a received camera lens and the camera image sensor are aligned to permit the camera function to be employed; and a plurality of camera lenses, wherein each of the plurality of camera lenses may be removably received into the first portion of the electronic device and interchanged with another of the plurality of camera lenses.

According to one embodiment of the camera system, the electronic device has a clamshell configuration such that the first portion and second portion may be pivoted about one another between the open and the closed position.

According to one embodiment of the camera system, the second portion of the electronic device includes a hinge portion in communication with an upper portion of the clamshell of the electronic device, and the first portion is a lower portion of the clamshell of the electronic device, wherein the camera image sensor is located in the hinge portion and the received camera lens is located in the lower portion of the clamshell.

According to one embodiment of the camera system, the electronic device has a slide cover configuration such that the first portion and the second portion may be slid longitudinally relative to one another between the open position and the closed position.

According to one embodiment of the camera system, each of the plurality of camera lenses is an autofocus lens.

According to one embodiment of the camera system, the electronic device further comprises a grommet, wherein when the electronic device is in the closed position, the grommet provides a sealing layer between the received camera lens and the camera image sensor.

According to one embodiment of the camera system, the electronic device further comprises a display viewable when the electronic device in the closed position, wherein the display acts as a viewfinder of the camera function.

According to one embodiment of the camera system, the first portion of the electronic device has screw threads, and each of the plurality of camera lenses has opposite screw threads for removably cooperating with the screw threads on the first portion.

According to one embodiment of the camera system, the electronic device is a mobile telephone.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device for use in accordance with an embodiment of the present invention.

FIG. 2 is a schematic view of the mobile telephone of FIG. 1 from the viewpoint of a user of the camera function of the mobile telephone.

FIG. 3 is a schematic view of the mobile telephone of FIG. 1 from the viewpoint of a subject to be photographed using the camera function of the mobile telephone.

FIG. 4 is a schematic view of a cross section of the mobile telephone of FIG. 1 along the line 4-4′ shown in FIG. 3.

FIG. 5 is a schematic view of a cross section of a slide-cover mobile telephone as an exemplary electronic device for use in accordance with an embodiment of the present invention.

FIG. 6 is a schematic block diagram of operative portions of the mobile telephone of FIG. 1.

FIG. 7 is a schematic diagram of a communications system in which the mobile telephone of FIG. 1 may operate.

### DETAILED DESCRIPTION OF EMBODIMENTS

The present invention provides the user with a multifunction portable electronic device having a high-resolution digital camera function in a clamshell configuration. A high-resolution camera is provided by separating the lens and image sensor of the camera, whereby each component resides in its own portion of the clamshell. The camera is thus employed when the clamshell is in the closed position. In this manner, the potential focal length is effectively doubled as compared to configurations in current typical clamshell portable electronic devices, in which both the lens and image sensor are located in the same portion of the clamshell. The potential resolution attained with the present invention is thus more comparable to the resolution in “stand-alone” digital cameras. A user, therefore, does not have to carry a separate digital camera to take acceptable photographs in situations when high resolution is desirable.

In one embodiment, the portable electronic device is a clamshell mobile telephone having an upper clamshell portion and a lower clamshell portion. The upper portion includes a hinge portion contiguous therewith and in cooperation with the lower clamshell portion. The lens is located in the lower portion of the clamshell, and the image sensor is located in the hinge portion of the upper clamshell portion. When the clamshell is closed, the lens and image sensor become optically aligned to permit using the camera function. Where the lens and image sensor come together when the telephone is in the closed position, a sealing grommet may be provided to block out stray light.

In another embodiment, the lens may be an autofocus lens to enhance photograph quality. In addition, the camera lens may be removable and interchangeable with alternative lenses, such as telephoto, macro, and/or other specialized lenses. In one embodiment, the mobile telephone and lens are provided with cooperating screw threads to permit a lens to be screwed on and off with respect to the mobile telephone, and then replaced in a comparable manner with another lens choice.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or similar. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

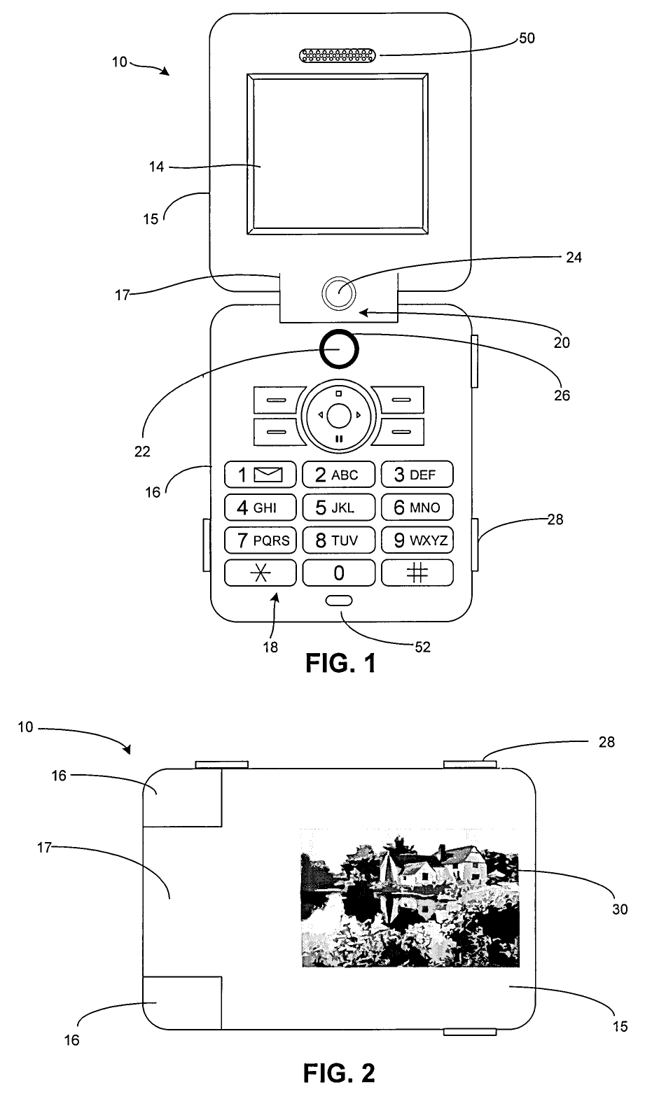

FIG. 1 depicts an exemplary mobile telephone 10. Mobile telephone 10 may be a clamshell phone with a flip-open cover movable between an open and a closed position. The clamshell may include an upper portion 15 and a lower portion 16. The upper portion 15 may include a hinge portion 17 substantially contiguous therewith, which is in cooperation with the lower portion 16. In FIG. 1, the clamshell telephone is shown in the open position. In operation, the upper portion 15 may be pivoted about the hinge portion 17 to a closed position in which the upper portion 15 substantially covers the lower portion 16. It will be appreciated that mobile telephone 10 may have other configurations in which the mobile telephone is divided substantially into two halves. Such other configurations may include a slide cover configuration or a swivel configuration, as are known in the art.

Mobile telephone 10 has a first display 14 viewable when the clamshell telephone is in the open position. The display 14 displays information to a user regarding the various features and operating state of the mobile telephone 10, and displays visual content received by the mobile telephone 10 and/or retrieved from a memory. A keypad 18 provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. Some or all of the keys may be used in conjunction with the display as soft keys. Keys or key-like functionality also may be embodied as a touch screen associated with the display 14. As further described below, keypad 18 may include various side buttons that may provide additional navigation and input operations. One of the side buttons may act as a shutter button 28 when the camera function is employed.

Mobile telephone 10 also includes a camera function 20. Camera function 20 may include a lens 22 and an image sensor 24. Those skilled in the art of digital photography will appreciate how the lens and image sensor operate to create a digital photograph. Generally, the lens focuses light onto the surface of the image sensor, which, with appropriate hardware, software, and/or firmware, processes the light into a digital photographic image. The resolution of the digital camera in part is determined by the focal length, which is the distance between the lens and the surface of the image sensor. All other features being equal, usually the greater the focal length, the greater the resolution of the camera. In a typical configuration of the camera function of a clamshell mobile telephone, the lens and image sensor are incorporated into one portion of the clamshell, such as upper portion 15. Such a configuration, however, may limit the resolution of the camera function because the permissible focal length is capped at about the thickness of one portion of the clamshell, which is about half the total thickness of the mobile telephone when in the closed position.

The current device increases the potential focal length by locating the lens in one portion of the clamshell and the image sensor in another portion of the clamshell. In a preferred embodiment, the lens 22 is located in the lower portion 16 and the image sensor 24 is located in the upper portion 15. The reason is that the lower portion 16, having the keypad and other input functions, tends to be slightly thicker than the upper portion 15 containing the display. Commensurately, the lens 22 of the camera function tends to be thicker than the image sensor 24. In one embodiment, the image sensor 24 may be located within the hinge portion 17 of the upper portion 15 of the clamshell. As is apparent from FIG. 1, when the clamshell of mobile telephone 10 is moved to the closed position, the lens 22 and image sensor 24 become optically aligned to permit use of the camera function. In this manner, the potential focal length of the camera may be increased, for example, to approximately the entire thickness of the mobile telephone in the closed position, or about twice that of the typical configuration. Enhanced resolution may be achieved because of the increased focal length.

Mobile telephone 10 also may include a grommet 26 to provide a sealing layer between the lens and image sensor when the clamshell is in the closed position. The grommet preferably is made of an opaque material that reduces any stray light that may otherwise travel between the portions of the closed clamshell. In one embodiment, the grommet 26 may be located about the lens 22 (as shown in FIG. 1), but the grommet alternatively may be located about the image sensor 24. The sealing grommet may be made of a rubber, foam, plastic, or other sealing material as is known in the art.

FIG. 2 is a schematic diagram of the mobile telephone 10 in the closed position. As seen by comparing FIG. 2 to FIG. 1, FIG. 2 depicts the closed mobile telephone rotated ninety degrees counter-clockwise from FIG. 1, with upper clamshell portion 15 facing outward from the page. The hinge portion 17 is on left side of upper portion 15, and sections of the lower clamshell portion 16 may be visible adjacent the hinge portion. FIG. 2 depicts how a user would see the mobile telephone 10 when using the camera function. As is apparent, the manner by which the user holds the mobile telephone when using the camera function is comparable to how a user would hold a stand-alone digital camera. This configuration, therefore, tends to be more comfortable during use than configurations typical to current mobile telephones.

Upper portion 15 may include a second display 30 that is viewable when the clamshell is in the closed position. In a non-camera mode, the second display 30 may display information about the state of the mobile telephone 10, such as, for example, signal strength, time, date, remaining battery power, etc. In a camera mode, second display 30 may be used as a viewfinder for the camera function. FIG. 2 depicts the mobile telephone in a camera mode, which may be entered by the user in any conventional manner, such as by pressing one of the side buttons. In the depiction of FIG. 2, second display 30 is acting as the camera viewfinder and displays the subject matter of a potential photograph. The mobile telephone 10 also may include a viewfinder (not shown) that is distinct and separate from the second display 30, as may be present in a conventional stand-alone digital camera. One of the side buttons may act as the camera shutter 28 in camera mode, and the user may take the photograph by pressing the shutter button.

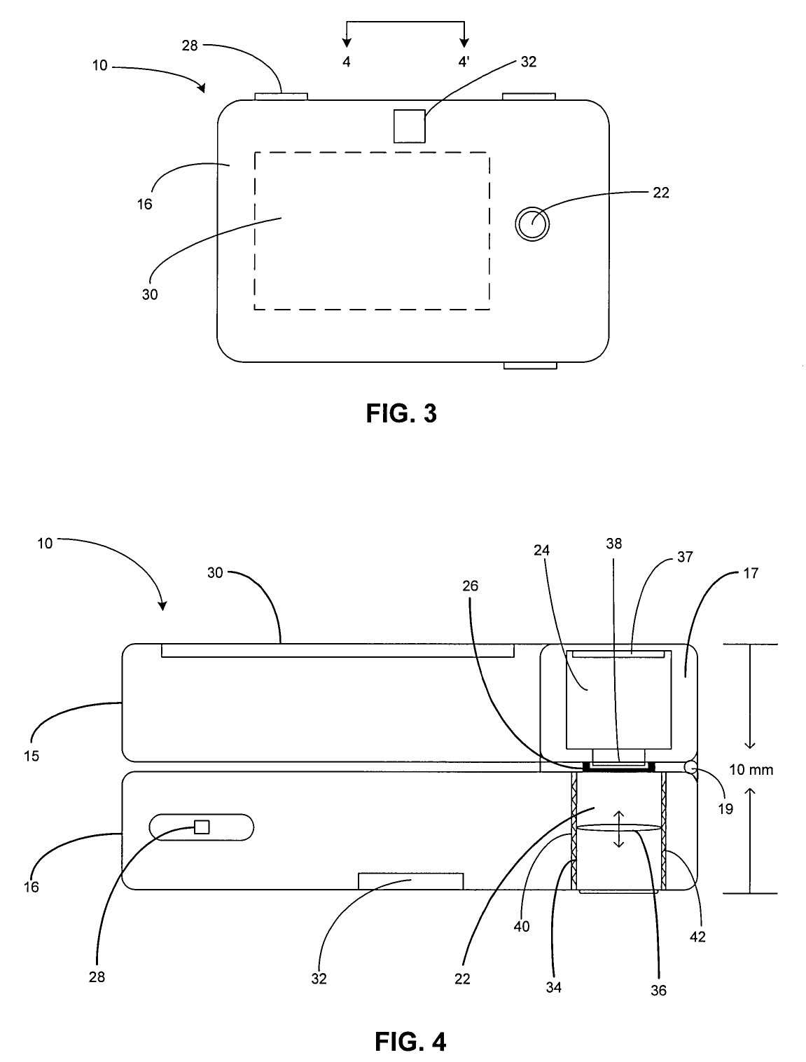

FIG. 3 depicts the view of mobile telephone 10 from the standpoint of a subject of a potential photograph. In other words, FIG. 3 is a view from the opposite side of the camera as that depicted in FIG. 2, as may be seen by one to be photographed. As shown in FIG. 3, the subject of a potential photograph would be facing the lower clamshell portion 16 and would see the lens 22. A built-in flash 32 also may be included in mobile telephone 10 as is conventional. The position of the second display 30 is depicted in FIG. 3. The dashed lines indicate that the second display would not be visible to the subject being photographed. Rather, the second display would be on the upper clamshell portion 15 on the opposite side of the mobile telephone, i.e., on the user's side.

FIG. 4 is a schematic view of a cross section of the mobile telephone 10 in the closed position along the viewing line 4-4′ shown in FIG. 3. For simplicity, FIG. 4 depicts only components of the mobile telephone 10 that may be pertinent to the camera function. Like structures present in other figures are numbered the same in FIG. 4.

Again, mobile telephone 10 may include upper clamshell portion 15, which may include the contiguous hinge portion 17. Hinge portion 17 may be in cooperation with the lower clamshell portion 16 via a pin 19 that permits the upper clamshell portion to pivot about the lower clamshell portion between open and closed positions. It will be appreciated that other ways of fastening the clamshell portions may be employed.

Upper portion 15 may include the second display 30 on the outside face thereof. Upper portion 15 also may include the image sensor 24 located within the hinge portion 17 of the upper portion 15. Image sensor 24 may be tipped with a protective layer 38 made of a clear plastic, glass, or comparable material. Protective layer 38 protects the image sensor from dust and damage while permitting light to pass through substantially unimpeded so as not to interfere with imaging a photograph. Image sensor 24 also may have a sensing layer 37 that actually senses the image to be photographed. For example, sensing layer 37 may be a charged-coupled device (CCD) array, or other image sensing device as are known in the art.

Lower portion 16 may include the shutter button 28, lens 22, and flash 32. Lens 22 may include a lens housing 34 and optical element 36. Optical element 36 functions as the actual lens. Lens 22 may include an autofocus feature as is known in the art. As indicated by the two-directional arrow present in FIG. 4, the autofocus feature causes the optical element 36 to move up or down within the housing 34 as needed to focus the image onto the sensing layer 37 of image sensor 24.

As an example based on a typical clamshell mobile telephone, the thickness of the closed mobile telephone may be as little as 10 mm. It will be understood by one skilled in the art that the focal length would be the distance between the optical element 36 and the sensing layer 37 of the image sensor 24. As is apparent from FIG. 4, therefore, the potential focal length of the present invention is increased to include substantially the entire thickness of the closed clamshell. Accordingly, the potential focal length is increased to approximately double that provided by the typical clamshell configuration, in which the lens and image sensor are contained within the same clamshell portion (whether upper or lower). Assuming other components all being equal, the larger focal length would tend to result in enhanced resolution. Applicant has found that, with current lens and image sensor technology, a resolution greater than three megapixels is readily attained, and a resolution of up to approximately five megapixels may be achieved, which is comparable to the resolution commonly found in many stand-alone digital cameras.

In one embodiment, lens 22 may be removably housed within the mobile telephone 10. In this embodiment, lens 22 may be one of a plurality of lenses 22 that may be interchanged to accommodate various photographic needs. For example, the lenses 22 may include a lens for ordinary photography, as well as telephoto, macro, and/or other specialized lenses. To provide this interchangeability, as shown in FIG. 4, lower clamshell portion 16 may include screw threads 40 that cooperate with opposite screw threads 42 on the housing 34 of each of the plurality of lenses 22.

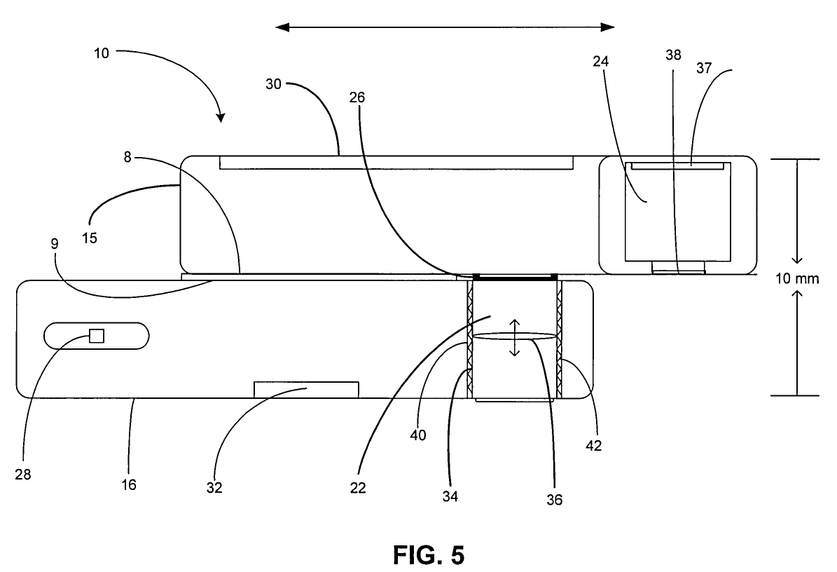

FIG. 5 represents an alternative embodiment in which the mobile telephone 10 has a slide cover configuration. The optical and camera elements are essentially the same as in previous embodiments. In the slide cover configuration, the hinge portion 17 and pin 19 may be absent, and instead there may be cooperating sliding elements 8 and 9 on upper and lower portions 15 and 16 respectively. The sliding elements may be rails, grooves, or similar structures that permit sliding relative to one another. In this embodiment, the upper and lower portions may be slid longitudinally relative to one another, as shown by the arrow in the figure, to optically align the lens and image sensor when in the closed position.

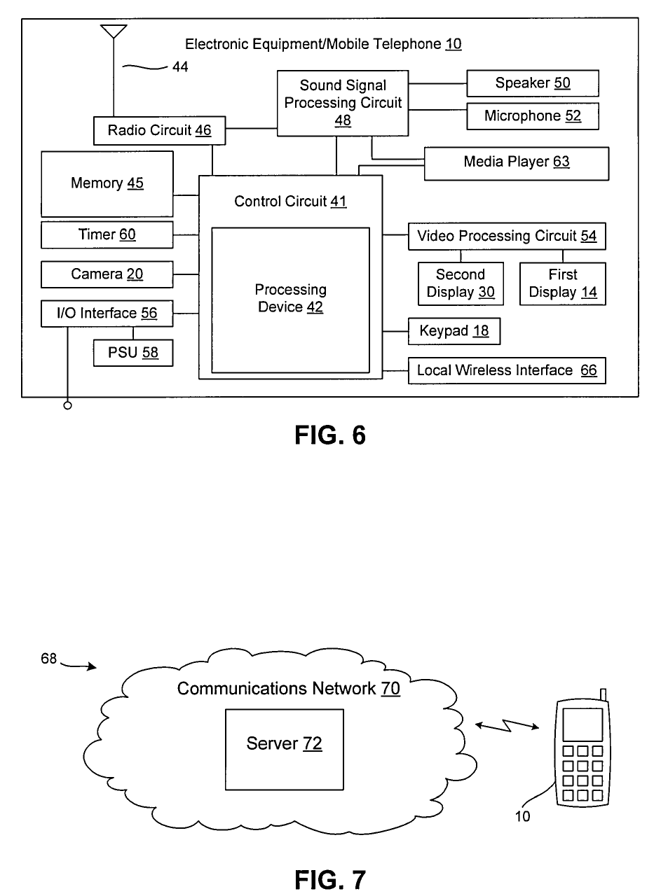

FIG. 6 represents a functional block diagram of the mobile telephone 10. For the sake of brevity, generally conventional features of the mobile telephone 10 will not be described in great detail herein. Mobile telephone 10 may include a camera function 20 as described above. The mobile telephone 10 also may include a memory 45 that may store various device functions as executable program code, as well as various media objects. The media objects may include digital photographs taken using the camera function 20.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include a primary control circuit 41 that is configured to carry out overall control of the functions and operations of the mobile telephone 10. The control circuit 41 may include a processing device 42, such as a CPU, microcontroller or microprocessor. The control circuit 41 and/or processing device 42 may comprise a controller that may execute program code embodied within the mobile telephone to control the various device functions. It will be apparent to a person having ordinary skill in the art of computer programming, and specifically in application programming for cameras, mobile telephones or other electronic devices, how to program a mobile telephone to operate and carry out logical functions associated with mobile telephone 10. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional (see also FIG. 1).

The first and second displays 14 and 30 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 46 or obtained by any other suitable method.

The mobile telephone 10 also may include a local wireless interface 66, such as an infrared transceiver and/or an RF adaptor (e.g., a Bluetooth adapter), for establishing communication with an accessory, another mobile radio terminal, a computer or another device. For example, the local wireless interface 66 may operatively couple the mobile telephone 10 to a headset assembly (e.g., a PHF device) in an embodiment where the headset assembly has a corresponding wireless interface.

The mobile telephone 10 also may include an I/O interface 56 that permits connection to a variety of I/O conventional I/O devices. One such device is a power charger that can be used to charge an internal power supply unit (PSU) 58. Mobile telephone 10 also may include a timer 60 and a media player 63 as are conventional.

Referring to FIG. 7, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. An electronic device having a camera function comprising:
a first portion having a camera lens; and
a second portion having a camera image sensor;
wherein the first portion and second portion are movable relative to one another between an open position and a closed position, such that when in the open position the camera lens and the camera image sensor are not optically aligned, and when in the closed position the camera lens and camera image sensor are optically aligned to permit the camera function to be employed.

2. The electronic device of claim 1, wherein the electronic device has a clamshell configuration such that the first portion and second portion may be pivoted about one another between the open position and the closed position.

3. The electronic device of claim 2, wherein the second portion includes a hinge portion in communication with an upper portion of the clamshell of the electronic device, and the first portion is a lower portion of the clamshell of the electronic device, wherein the camera image sensor is located in the hinge portion and the camera lens is located in the lower portion of the clamshell.

4. The electronic device of claim 1, wherein the electronic device has a slide cover configuration such that the first portion and the second portion may be slid longitudinally relative to one another between the open position and the closed position.

5. The electronic device of claim 1, wherein the camera lens is an autofocus lens.

6. The electronic device of claim 1, further comprising a grommet, wherein when the electronic device is in the closed position, the grommet provides a sealing layer between the camera lens and the camera image sensor.

7. The electronic device of claim 1, further comprising a display viewable when the electronic device in the closed position, wherein the display acts as the viewfinder of the camera function.

8. The electronic device of claim 1, wherein the first portion has a receptor for removably receiving the camera lens.

9. The electronic device of claim 8, wherein the receptor of the first portion comprises screw threads, and the camera lens has opposite screw threads for removably cooperating with the screw threads on the first portion.

10. The electronic device of claim 1, wherein the resolution of the camera function is at least three megapixels.

11. The electronic device of claim 1, wherein the electronic device is a mobile telephone.

12. A camera system comprising:
an electronic device having a camera function comprising a first portion for removably receiving a camera lens and a second portion having a camera image sensor, wherein the first and second portions are movable relative to one another between an open position and a closed position, such that when in the open position a received camera lens and the camera image sensor are not optically aligned, and when in the closed position a received camera lens and the camera image sensor are aligned to permit the camera function to be employed; and
a plurality of camera lenses, wherein each of the plurality of camera lenses may be removably received into the first portion of the electronic device and interchanged with another of the plurality of camera lenses.

13. The camera system of claim 12, wherein the electronic device has a clamshell configuration such that the first portion and second portion may be pivoted about one another between the open and the closed position.

14. The camera system of claim 13, wherein the second portion of the electronic device includes a hinge portion in communication with an upper portion of the clamshell of the electronic device, and the first portion is a lower portion of the clamshell of the electronic device, wherein the camera image sensor is located in the hinge portion and the received camera lens is located in the lower portion of the clamshell.

15. The camera system of claim 12, wherein the electronic device has a slide cover configuration such that the first portion and the second portion may be slid longitudinally relative to one another between the open position and the closed position.

16. The camera system of claim 12, wherein each of the plurality of camera lenses is an autofocus lens.

17. The camera system of claim 12, wherein the electronic device further comprises a grommet, wherein when the electronic device is in the closed position, the grommet provides a sealing layer between the received camera lens and the camera image sensor.

18. The camera system of claim 12, wherein the electronic device further comprises a display viewable when the electronic device in the closed position, wherein the display acts as a viewfinder of the camera function.

19. The camera system of claim 12, wherein the first portion of the electronic device has screw threads, and each of the plurality of camera lenses has opposite screw threads for removably cooperating with the screw threads on the first portion.

20. The camera system of claim 12, wherein the electronic device is a mobile telephone.
